(19) United States
(12) Patent Application Publication
(10) Pub. No.: US 2009/0021506 A1
(43) Pub. Date: Jan. 22, 2009

(54) PLASMA DISPLAY DEVICE AND DRIVING METHOD THEREOF

(76) Inventor: Jong-Wook Kim, Suwon-si (KR)

Correspondence Address: CHRISTIE, PARKER & HALE, LLP, PO BOX 7068, PASADENA, CA, 91109-7068, US

(21) Appl. No.: 12/170,332

(22) Filed: Jul. 9, 2008

(30) Foreign Application Priority Data
Jul. 18, 2007 (KR) 10-2007-0071704

(51) Int. Cl. G09G 5/00; G09G 3/28

(52) U.S. Cl. 345/211; 345/60

(57) ABSTRACT

A plasma display device and a driving method is provided. An inverse gamma corrector generates a first video signal by mapping an input video signal to an inverse gamma curve, and an address APC unit determines an address power consumption level of the first video signal. When the address power consumption level is high, the address APC unit outputs a gamma gain to the inverse gamma corrector to generate a second inverse gamma curve by multiplying the inverse gamma curve by the gamma gain. and A second video signal is generated by mapping the input video signal to the second inverse gamma curve. When the address power consumption level of the second video signal is low, a controller of the plasma display device generates address data and a sustain pulse. This way, the address power consumption level of the displayed image can be reduced.

### CROSS-REFERENCE TO RELATED APPLICATION

This application claims priority to and the benefit of Korean Patent Application No. 10-2007-0071704 filed in the Korean Intellectual Property Office on Jul. 18, 2007, the entire content of which is incorporated herein by reference.

### BACKGROUND OF THE INVENTION

1. Field of the Invention

The present invention relates to a plasma display device and a driving method thereof.

2. Description of the Related Art

A plasma display device is a flat panel display that uses plasma generated by a gas discharge to display characters or images. It includes a plasma display panel (PDP) wherein hundreds of thousands to millions of discharge cells are arranged in a matrix format, depending on its size. Such a PDP is classified as a direct current (DC) type or an alternating current (AC) type according to its discharge cell structure and the waveform of the driving voltage applied thereto.

A driving method of the AC PDP divides a frame into a plurality of subfields, each including a reset period, an address period, and a sustain period with respect to time. The reset period is for initializing the status of each discharge cell so as to facilitate an addressing operation on the discharge cells. The address period is for selecting turn-on/turn-off cells (i.e., cells to be turned on or off) and accumulating wall charges to the turn-on cells (i.e., addressed cells) by applying an address voltage thereto. In addition, the sustain period is for causing a discharge for displaying an image on the addressed cells.

When the operations (reset, address, and sustain operations) are performed in the respective periods of each subfield according to the above-described method, a discharge space formed between a scan electrode and a sustain electrode and between an area where the address electrode is formed and an area where the scan and sustain electrodes are formed operates as a capacitive load, and therefore capacitance exists on the panel. Therefore, a lot of reactive power for charge injection is required to generate a predetermined voltage in a capacitor in addition to power for an address discharge in order to apply waveforms for addressing.

The address power consumption occurs due to a switching operation of an address pulse. That is, an address pulse is switched according to display image data so that a panel capacitor component is charged and discharged in accordance with the switching operation of the address pulse, consuming reactive power. A level of the address power consumption may be significantly changed depending on the display image data, and a load of a drive integrated circuit (IC) may increase when the address power consumption level is relatively high, thereby generating excessive heat. The excessive heat may damage the drive IC and increase overall power consumption.

Conventionally, an address data control method has been suggested to control the address power consumption. However, this method has a problem of reducing the number of sustain discharges when controlling the address data, thereby reducing luminance.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments in accordance with the present invention provide a plasma display device that controls address power consumption and maintains luminance of an input image at a substantially uniform level, and a driving method thereof.

An exemplary method according to one embodiment of the present invention drives a plasma display device for displaying an image by dividing one frame of an input video signal into a plurality of subfields. The method includes: generating a first video signal by mapping the input video signal to a first inverse gamma curve; determining whether the first video signal has an address power consumption level that is higher or lower than a threshold level; when the address power consumption level of the first video signal is lower than the threshold level, displaying the first video signal on the plasma display device; when the address power consumption level of the first video signal is higher than the threshold level, generating a second inverse gamma curve by multiplying the first gamma curve by a gamma gain and generating a second video signal by mapping the input video signal to the second gamma curve.

An exemplary plasma display device according to another embodiment of the present invention includes a plasma display panel (PDP), a controller, and a driver. The PDP has a plurality of first electrodes, a plurality of second electrodes, and a plurality of third electrodes crossing the first and second electrodes. The controller generates a first video signal by mapping an input video signal to a first inverse gamma curve to generate a first video signal, and determines an address power consumption level of the first video signal. The driver drives the first, second, and third electrodes according to a control signal generated by the controller. When the address power consumption level of the first video signal is lower than a threshold level, the controller calculates a first load ratio using the first video signal and calculates a first number of sustain pulses according to the first load ratio. When the address power consumption level of the first video signal is higher than the threshold level, the controller generates a second inverse gamma curve by multiplying the first inverse gamma curve by a gamma gain, generates a second video signal by mapping the input video signal to the second gamma curve, calculates a second load ratio using the second video signal, and calculates a second number of sustain discharge pulses according to the second load ratio.

### BRIEF DESCRIPTION OF THE DRAWINGS

FIG. 1 is a schematic diagram of a plasma display panel (PDP) according to an exemplary embodiment of the present invention.

FIG. 2 is a block diagram of a controller of the PDP that reduces address power consumption according to an exemplary embodiment of the present invention.

FIG. 3 shows a corrected inverse gamma curve according to an exemplary embodiment of the present invention.

FIG. 4 is a block diagram showing an internal configuration of an address APC unit according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

A plasma display device and a driving method thereof according to an exemplary embodiment of the present invention will now be described in further detail with reference to the accompanying drawings.

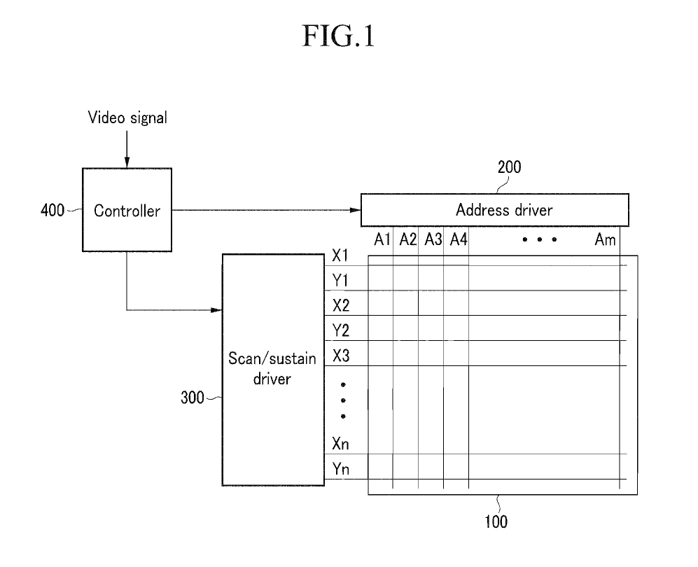

FIG. 1 is a schematic diagram of a plasma display device according to an exemplary embodiment of the present invention.

As shown in FIG. 1, the plasma display device according to the exemplary embodiment of the present invention includes a plasma display panel (PDP) 100, an address driver 200, a scan/sustain driver 300, and a controller 400.

The PDP 100 includes a plurality of address electrodes A1 to Am extending in a column direction and a plurality of scan electrodes Y1 to Yn and sustain electrodes X1 to Xn extending in a row direction in an alternating manner. The address driver 200 receives an address driving control signal from the controller 400, and applies a display data signal to the respective address electrodes A1 to Am for selecting discharge cells to be displayed. The scan/sustain driver 300 receives a control signal from the controller 400, and alternately applies a sustain discharge voltage to the scan electrodes Y1 to Yn and the sustain electrodes X1 to Xn to perform a sustain discharge on selected discharge cells.

The controller 400 externally receives a red (R) video signal, a green (G) video signal, a blue (B) video signal, and a synchronization signal, and drives the plasma display device by dividing one frame into a plurality of subfields. Each subfield is divided into a reset period, an address period, and a sustain period. Here, the controller 400 controls the number of sustain discharge pulses to be included in one frame and supplies a necessary control signal to the address driver 200 and the scan/sustain driver 300.

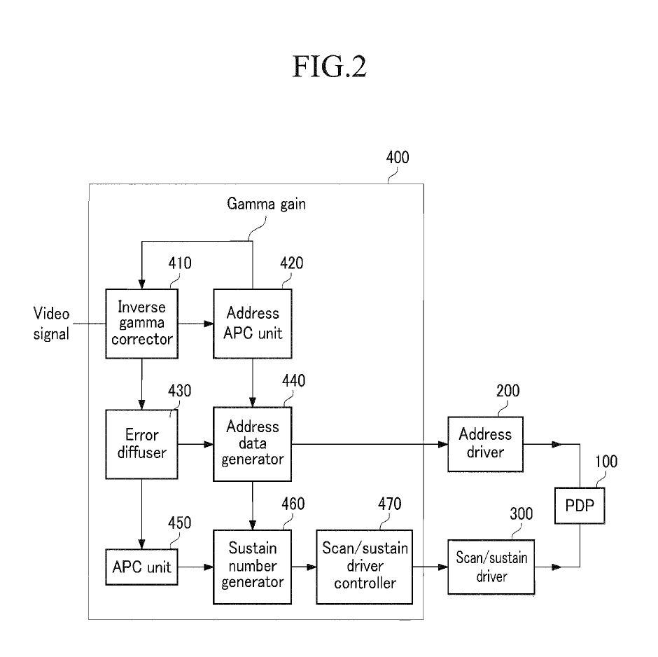

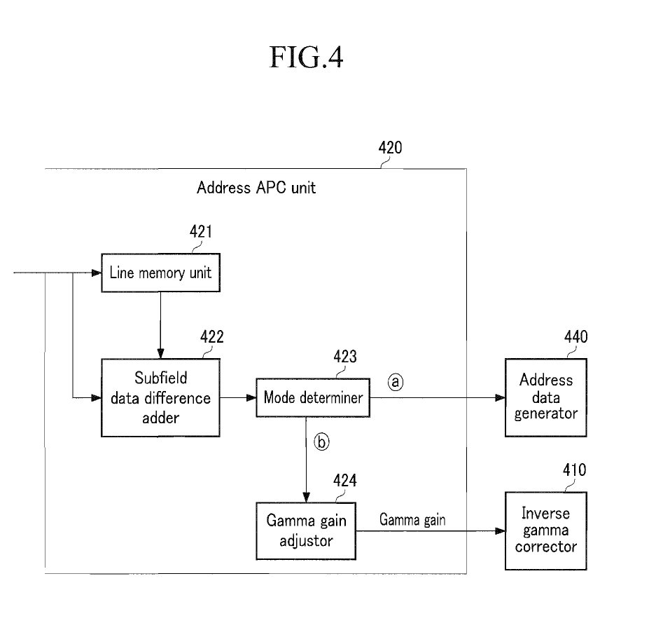

The controller 400 of the plasma display device according to an exemplary embodiment of the present invention will be described in further detail with reference to FIG. 2 and FIG. 4.

FIG. 2 is a block diagram of the controller 400 of the plasma display device that reduces address power consumption according to the exemplary embodiment of the present invention.

As shown in FIG. 2, the controller 400 includes an inverse gamma corrector 410, an address automatic power control (APC) unit 420, an error diffuser 430, an address data generator 440, an APC unit 450, a sustain number generator 460, and a scan/sustain driver controller 470.

The inverse gamma corrector 410 corrects an input video signal into a bit-converted video signal by mapping the input video signal to an inverse gamma curve. That is, the inverse gamma corrector 410 generates corrected R, G, B video signals, each color signal having p bits by mapping R, G, B video signals, each color signal having q bits, to the inverse gamma curve. Here, p is greater than q. In a typical plasma display device, q corresponds to 8 and p corresponds to 10 or 12. In this case, the video signal input to the inverse gamma corrector 410 is a digital signal, and therefore when an analog video signal is input to the plasma display device, the analog video signal is converted to a digital video signal by using an analog-to-digital converter (not shown). In addition, the inverse gamma corrector 410 may include a logic circuit (not shown) to generate data corresponding to the inverse gamma curve to which the video signal is mapped by performing a logic operation.

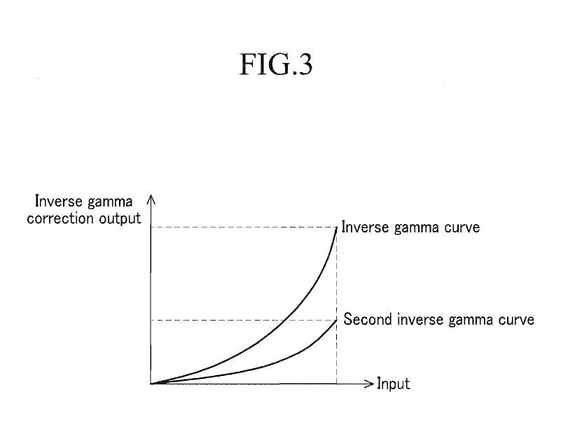

In the present exemplary embodiment, the inverse gamma curve to which the video signal is mapped is changed in accordance with an address power consumption level. The inverse gamma corrector 410 generates a first video signal by mapping an input video signal to the inverse gamma curve, and the address APC unit 420 determines an address power consumption level of the first video signal. When the address APC unit 420 determines that the address power consumption level of the first video signal is high (e.g., higher than a threshold level), the address APC unit 420 outputs a gamma gain value to the inverse gamma corrector 410, and the inverse gamma corrector 410 generates a corrected inverse gamma curve by multiplying the inverse gamma curve by a gamma gain value that is less than 1. Hereinafter, the corrected gamma curve will be referred to as a second inverse gamma curve. FIG. 3 shows the second inverse gamma curve. The inverse gamma corrector 410 generates a second video signal by mapping the input video signal to the second inverse gamma curve, and the address APC unit 420 determines an address power consumption level of the second video signal. When it is determined that an image has a low address power consumption level (e.g., lower than a threshold level), a subsequent process is carried out.

An inverse gamma curve controls a grayscale of an image. That is, a slope of the overall inverse gamma curve is reduced by multiplying a typical inverse gamma curve by a gamma gain value that is less than 1 such that a grayscale to be displayed can be reduced. In other words, the grayscale can be reduced by mapping the video signal to the second inverse gamma curve with a reduced slope, thereby reducing the number of subfields to be used.

The address APC unit 420 determines an address power consumption level from output data of the inverse gamma corrector 410, and outputs a gamma gain value to the inverse gamma corrector 410 when the address power consumption level is relatively high. In addition, when address power consumption level is relatively low, the address APC unit 420 outputs a control signal to the address data generator 440 for generation of address data. In this case, the address APC unit 420 can determine an address power consumption level of data in one frame based on an on/off status of each subfield data, and a method for determining the on/off status of each subfield data will now be described in further detail. Herein, the on/off status of the subfield data indicates a data difference between a subfield of a previous cell and a subfield of a cell adjacent to the previous cell in a row direction of an address electrode on the same row.

The error diffuser 430 diffuses a least significant (p-q)-bit image of a p-bit image that is expanded after being inverse-gamma-corrected by the inverse gamma corrector 410 to adjacent pixels, such that a q-bit image is displayed. The error diffusion method includes dividing a lower-bit image and diffusing the lower-bit image to adjacent pixels, and this method is well known to a person of ordinary skill in the art and therefore further description will be omitted.

When receiving the control signal for generation of address data from the address APC unit 420, the address data generator 440 generates subfield data corresponding to data output from the error diffuser 430, generates an address control signal for controlling the address driver 200 by rearranging the subfield data to address data for driving the plasma display device, and outputs the address control signal to the address driver 200.

The APC unit 450 detects a load ratio by using image data output from the error diffuser 430, calculates an APC level according to the detected load ratio, and computes and outputs the number of sustain discharge pulses (i.e., the number of sustain pulses) corresponding to the calculated APC level.

The sustain number generator 460 allocates a number of sustain pulses (i.e., a number of sustain discharge pulses) of each subfield by using information on the number of sustain pulses (i.e., sustain discharge pulses) transmitted from the APC unit 450.

The scan/sustain driver controller 470 generates a control signal corresponding to the number of sustain discharge pulses output from the sustain number generator 460 and outputs the control signal to the scan/sustain driver 300. Although the sustain number generator 460 and the scan/sustain driver controller 470 are separately provided in the present exemplary embodiment of the present invention, they can be realized within one block.

FIG. 4 is a block diagram of an internal configuration of the address APC 420 according to the exemplary embodiment of the present invention.

As shown in FIG. 4, the address APC unit 420 includes a line memory unit 421, a subfield data difference adder 422, a mode determiner 423, and a gamma gain adjustor 424.

The subfield data difference adder 422 of the address APC unit 420 adds a subfield data difference between upper and lower lines (i.e., row lines) adjacent in the column direction by using data converted to subfield data. Herein, the data converted to the subfield data corresponds to an input video signal converted to on/off data for each subfield. In this case, a data processor (not shown in FIG. 4) may be included before the subfield data difference adder 422. That is, the data processor converts the input video signal into the on/off data for each subfield. In the case that a sustain period of one frame of a PDP is divided into eight subfields SF1 to SF8 and then driven for representing 256 grayscales, the data processor converts a video signal with a grayscale of 100 into an eight-bit data (i.e., 00100110). Herein, the subfields SF1 to SF8 respectively have weight values of 1, 2, 4, 8, 16, 32, 64, and 128. Each bit of the eight bits (00100110) sequentially corresponds to the eight subfields SF1 to SF8, and “0” indicates that a discharge cell (dot) of the corresponding subfield is not discharged (off status) and “1” indicates that a discharge cell of the corresponding subfield is discharged (on status).

The subfield data difference adder 422 adds a subfield data difference of adjacent rows from the video signal that has been converted into the on/off data for each subfield by the data processor, and adds the added subfield data difference of all the subfields of the frame. A switching operation that consumes a lot of address power is performed when one of two discharge cells adjacent in the column direction (i.e., a vertical direction in FIG. 1) is in the on-status state and the other is in the off-status state, and therefore the subfield data difference adder 422 can calculate a total of a sum of an on/off data difference between two adjacent discharge cells in the column direction for each subfield.

$$AP = {\sum }_{i = 1}^{n - 1} {\sum }_{j = 1}^{m} ( \vert {R}_{ij} - {R}_{( i + 1 ) j} \vert + \vert {G}_{ij} - {G}_{( i + 1 ) j} \vert + \vert {B}_{ij} - {B}_{( i + 1 ) j} \vert ) \qquad Equation 1$$

Here, Rᵢⱼ, Gᵢⱼ, and Bᵢⱼ respectively denote on/off data of a red (R) discharge cell, a green (G) discharge cell, and a blue (B) discharge cell, of the i-th row and the j-th column, respectively. In this case, the subfield data difference adder 422 calculates a sum of each subfield by using Equation 1, and adds the sum of the respective subfields that form one frame. An address power consumption level (e.g., whether it is high or low) for each subfield can be determined with reference to a sum of a subfield data difference for each subfield, calculated by using Equation 1, and the address power consumption level (e.g., whether it is high or low) for the frame can be determined by a sum of the subfield data differences calculated by using Equation 1 of all the subfields.

In general, a video signal is serially input in a row order, and therefore the line memory unit 421 is further included to store a video signal of one row so as to calculate an on/off data difference of two adjacent discharge cells, as shown in FIG. 4. When on/off data of each subfield for a video signal of one row (i.e., one line) is input, the line memory unit 421 sequentially stores the input on/off data, and the subfield data difference adder 422 calculates an on/off data difference of two adjacent discharge cells by analyzing data of the previous row (i.e., previous line) stored in the line memory unit 421. In addition, the address APC unit 420 may calculate the on/off data difference for each subfield of the two adjacent discharge cells by performing the exclusive OR (XOR) operation.

The mode determiner 423 determines whether a sum of the on/off data difference of each subfield calculated by Equation 1 is greater than a threshold value. The mode determiner 423 determines that a mode of the inverse-gamma-corrected video signal is a special mode that consumes a large amount of address power when the sum is greater than the threshold value, and determines that a mode of the inverse-gamma-corrected video signal is a normal mode that does not consume a large amount of address power when the sum is less than the threshold value. When the inverse-gamma-corrected video signal is determined to correspond to the normal mode (a direction of \textcircled{a} in FIG. 4), the mode determiner 423 outputs a control signal to the address data generator 440 for generation of address data. When the inverse-gamma-corrected video signal is determined to correspond to the special mode (a direction of \textcircled{b} in FIG. 4), the mode determiner 423 outputs a special mode indication signal to the gamma gain adjustor 424 and the gamma gain adjustor 424 outputs a gamma gain value to the inverse gamma corrector 410. Although the mode determiner 423 and the gamma gain adjustor 424 are separately provided in the present exemplary embodiment, they can be realized within one block in other embodiments.

In general, an address data control method is used to control an address power consumption level. That is, the number of switching events on the address electrode is controlled by controlling the address data generation process performed after the input video signal is inverse-gamma-corrected. However, although the address power consumption level can be controlled by controlling the address data generation process, the address data generation was performed without considering the number of sustain discharge pulses. Accordingly, luminance of a displayed image is decreased. However, according to the exemplary embodiment of the present invention, the address power consumption level can be controlled by correcting the inverse gamma curve. When the inverse gamma curve is corrected, data input to the address data generator 440 corresponds to data input to the APC unit 450. Therefore, when the address power consumption level of image data is less than the threshold value, address data and a sustain pulse are generated so that the address power consumption level can be controlled and at the same time luminance can be maintained at a substantially uniform level.

According to the exemplary embodiment of the present invention, a plasma display device that can control an address power consumption level and maintain luminance of an input image, and a driving method of the plasma display device, are provided.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method for driving a plasma display device for displaying an image by dividing one frame of an input video signal into a plurality of subfields, the method comprising:
generating a first video signal by mapping the input video signal to a first inverse gamma curve;
determining whether the first video signal has an address power consumption level that is higher or lower than a threshold level;
when the address power consumption level of the first video signal is lower than the threshold level, displaying the first video signal on the plasma display device;
when the address power consumption level of the first video signal is higher than the threshold level, generating a second inverse gamma curve by multiplying the first gamma curve by a gamma gain and generating a second video signal by mapping the input video signal to the second gamma curve.

2. The method of claim 1, wherein the determining of whether the first video signal has the address power consumption level that is higher or lower than the threshold level uses subfield data of adjacent upper and lower lines in a same column among video signal data corresponding to one frame of the first video signal.

3. The method of claim 2, further comprising, when the address power consumption level of the first video signal is higher than the threshold level:
calculating a load ratio using the second video signal;
calculating a number of sustain discharge pulses according to the load ratio; and
outputting the number of sustain discharge pulses.

4. The method of claim 1, wherein the gamma gain is less than 1.

5. A plasma display device comprising:
a plasma display panel (PDP) having a plurality of first electrodes, a plurality of second electrodes, and a plurality of third electrodes crossing the first and second electrodes;
a controller for generating a first video signal by mapping an input video signal to a first inverse gamma curve to generate a first video signal, and determining an address power consumption level of the first video signal; and
a driver for driving the first, second, and third electrodes according to a control signal generated by the controller,
wherein the controller is adapted to:
when the address power consumption level of the first video signal is below a threshold level, calculate a first load ratio using the first video signal and calculate a first number of sustain pulses according to the first load ratio, and
when the address power consumption level of the first video signal is higher than the threshold level, generate a second inverse gamma curve by multiplying the first inverse gamma curve by a gamma gain, generate a second video signal by mapping the input video signal to the second gamma curve, calculate a second load ratio using the second video signal, and calculate a second number of sustain discharge pulses according to the second load ratio.

6. The plasma display device of claim 5, wherein the controller is further adapted to determine the address power consumption level using subfield data of adjacent upper and lower lines in a same column among video signal data corresponding to one frame of the first video signal.

7. The plasma display device of claim 5, wherein the gamma gain is less than 1.

8. The plasma display device of claim 5, wherein the controller comprises an inverse gamma corrector for mapping the input video signal to the first inverse gamma curve to generate the first video signal.

9. The plasma display device of claim 8, wherein the inverse gamma corrector is further adapted to map the input video signal to the second gamma curve to generate the second video signal when the address power consumption level of the first video signal is higher than the threshold level.

10. The plasma display device of claim 9, wherein the controller comprises an address power control unit for determining the address power consumption level of the first video signal, and for providing the gamma gain to the inverse gamma corrector, and wherein the inverse gamma corrector is further adapted to multiply the first gamma curve with the gamma gain to generate the second gamma curve.

11. A plasma display device for displaying an image by dividing one frame of an input video signal into a plurality of subfields, the plasma display device comprising:
a controller for generating a first video signal by mapping an input video signal to a first inverse gamma curve; and
an address power control unit for determining whether the first video signal has an address power consumption level higher or lower than a threshold level,
wherein when the address power consumption level of the first video signal is lower than the threshold level, the first video signal is displayed on the plasma display device, and
wherein when the address power consumption level of the first video signal is higher than the threshold level, a second inverse gamma curve is generated by multiplying the first gamma curve by a gamma gain, and a second video signal is generated by mapping the input video signal to the second gamma curve.

12. The plasma display device of claim 11, further comprising an inverse gamma corrector adapted to generate the second gamma curve.

13. The plasma display device of claim 11, where the controller is further adapted to generate the second video signal by mapping the input video signal to the second gamma curve.

14. The plasma display device of claim 11, further comprising:
an error diffuser for diffusing at least one lower significant bit of the first video signal corresponding to one pixel to adjacent neighboring pixels;
an address data generator adapted to receive a control signal from the address power control unit, to generate subfield data corresponding to data output from the error diffuser, and to generate an address control signal for controlling a driver.

15. The plasma display device of claim 14 further comprising:
a power control unit adapted to detect a load ratio using data output from the error diffuser; and to calculate a number of sustain pulses; and
a sustain number generator for allocating the number of sustain pulses to each of the plurality of subfields.

16. The plasma display device of claim 11 further comprising a driver for generating a control signal for displaying the image.
